(19) United States
(12) Patent Application Publication
(10) Pub. No.: US 2026/0166673 A1
(43) Pub. Date: Jun. 18, 2026

(54) Changing Station for the Automatic Changing of Abrasive Devices

(71) Applicant: FerRobotics Compliant Robot Technology GmbH, Linz (AT)

(72) Inventors: Ronald Naderer, Linz (AT); Gregor Pree, Linz (AT); Michael Haas, Linz (AT); Stefan Hofer, Linz (AT)

(21) Appl. No.: 19/122,457

(22) PCT Filed: Oct. 18, 2023
(86) PCT No.: PCT/EP2023/079031

§ 371 Date: Apr. 18, 2025

(30) Foreign Application Priority Data
Oct. 20, 2022 (DE) 102022127707.0

(51) Int. Cl. B24B 41/00; B24D 9/08; B25J 11/00; B25J 15/04

(52) U.S. Cl. CPC B24B 41/005; B24D 9/085; B25J 11/0065; B25J 15/04

(57) ABSTRACT

The invention relates to components of a changing station for automatically changing abrasive devices (abrasive disks) of a robot-assisted grinding device and to the associated methods for mounting grinding devices to a grinder and for removing worn grinding devices from the grinder.

### TECHNICAL FIELD

The present invention relates to a changing station which enables a robot-assisted grinding device to automatically change grinding means, such as grinding fleece discs (also referred to as “non-woven abrasive”).

### BACKGROUND

Grinders such as orbital grinders are widely used in industry and handicraft. Orbital grinders are grinders in which a rotational movement about an axis of rotation is superimposed on an oscillating movement (vibration). They frequently serve for final processing of surfaces with high requirements for surface quality. In order that these requirements can be met, irregularities during the grinding process should be avoided as far as possible. This is usually achieved in practice in that these tasks, in particular in the production of small numbers, are performed by experienced skilled workers.

In the case of robot-assisted grinding devices, a grinding tool (e.g. an orbital grinder) is guided by a manipulator, for example an industrial robot. In this case the grinding tool can be coupled in different ways to what is known as the end-effector of the manipulator, the position of which specifies the TCP (Tool Centre Point), such that the manipulator can position the machine tool virtually as desired. Industrial robots are typically controlled by position, which allows for a precise movement of the TCP along a desired trajectory. In order to achieve a good result in the case of robot-assisted grinding, in many applications a regulation of the process force (grinding force) is necessary, which can often be achieved with sufficient accuracy only with difficulty using conventional industrial robots. The large and heavy arm segments of an industrial robot have too great an inertia for a controller (closed-loop controller) to be able to react quickly enough to fluctuations of the process force. In order to solve this problem, a small linear actuator can be arranged between the end-effector of the manipulator and the grinding tool compared with the industrial robot, which linear actuator couples the end-effector of the manipulator to the grinding tool. The linear actuator merely controls the process force (i.e. the contact force between the tool and workpiece), while the manipulator moves the grinding tool, together with the linear actuator, along a specifiable trajectory in a position-controlled manner.

In the case of robot-assisted grinding, changing stations are used, with the aid of which the robot grinding means (e.g. the grinding discs) can be changed automatically. The changing station generally comprises a removal unit, by means of which worn grinding discs can be removed from the carrier plate (packing pad) of the grinder, and a magazine comprising new grinding discs, which is constructed such that the robot can “collect” a new grinding disc form the magazine and can fasten this to the carrier plate. In many applications, grinding discs are fixed to the carrier plate by means of a hook-and-loop fastener (Velcro fastener).

Changing stations for automatic changing of grinding means are generally configured specifically for a particular type of grinding means. In many grinding processes, grinding discs made of grinding fleece, which is also referred to as non-woven abrasive, is used. In contrast to grinding discs made of sanding paper, grinding discs made of grinding fleece are substantially thicker and softer, which has impacts on the requirements of the changing process (for example, fleece can tear more easily than paper). Although some concepts for robot-assisted changing stations for changing grinding discs exist, known solutions are comparatively complex, laborious to achieve, and therefore expensive. Frequently, even in the case of robot-assisted grinding processes, worn grinding discs are still exchanged manually.

### SUMMARY

An object of the present invention can therefore be considered to be that of providing a removal unit and a magazine which allows for automatic changing of grinding discs (in particular of comparatively thick and soft grinding discs, such as grinding fleece discs) for a robot-assisted grinder in a comparatively simple and nonetheless reliable manner.

The above-mentioned object is achieved by the devices and methods described herein.

A method for removing a grinding means from a robot-assisted grinder is described in the following. According to an embodiment, the method comprises the following: positioning the grinder on a curved deposition element of a removal device close to a clamping mechanism of the removal device, by means of a manipulator; clamping the grinding means by closing the clamping device; performing a rolling movement of the grinder with the aid of the manipulator while the grinding means touches the curved deposition element, as a result of which the grinding means is in part released from a carrier plate of the grinder; retracting the grinder with the aid of the manipulator, such that the grinding means is detached completely from the carrier plate; and releasing the clamping mechanism.

Furthermore, a method for automatic mounting of a grinding means provided in a magazine, on a carrier plate of a robot-assisted grinder, is described. According to an embodiment, the method comprises the following: pressing the grinding means (e.g. the uppermost in a grinding means stack) against the rear side of a retaining ring with the aid of a linear actuator, wherein the linear actuator is force-regulated and the grinding means is pressed against the retaining ring with a defined contact force; positioning the grinder via the magazine, and pressing the carrier plate of the grinder against an upper side of the retaining ring, with the aid of a manipulator, as a result of which the grinding means adheres to the carrier plate; reducing the contact force from a first value to a second, lower value; and—subsequently—retracting the grinder from the magazine with the aid of the manipulator, as a result of which the grinding means adhering to the carrier plate is pulled out of the magazine through the retaining ring. After the retraction of the grinder, the pressure force can be increased again to the first value.

The removal device and the device comprising the magazine can be combined to form a changing station for automatically changing grinding means. According to an embodiment, the removal device comprises the following, for removing a grinding means from a robot-assisted grinder: a curved deposition element for the grinding means, which is mounted on a carrier plate of the grinder, and a clamping mechanism which is configured for clamping the grinding means by closing the clamping mechanism in a clamping direction, while the grinding means is located obliquely on the curved deposition element, with respect to the clamping direction.

According to an embodiment, the device for automatic mounting of a grinding means provided in a magazine on a carrier plate of a robot-assisted grinder comprises the following: the magazine, which is configured for receiving a stack of grinding means, wherein the magazine comprises a retaining ring; a linear actuator which is configured for pressing the stack of grinding means against the retaining ring; a controller for the linear actuator, which is configured for setting the contact force, with which the stack of grinding means is pressed against the retaining ring, such that the contact force is initially of a defined first value, wherein the controller is configured for reducing the contact force from the first value to a second, lower value, while the stack of grinding means is still pressed against the retaining ring, in order to allow for easier withdrawal of the uppermost grinding means of the stack.

### BRIEF DESCRIPTION OF THE DRAWINGS

The invention will be explained in greater detail in the following, with reference to the examples shown in the figures. The illustrations are not necessarily true to scale, and the invention is not only limited to the aspects shown. Rather, what is important is to show the principles on which the invention is based. In the drawings:

FIG. 1 schematically shows an example of a robot-assisted grinder.

FIG. 2 schematically shows the grinding tool and the grinding disc, as well as the fastening of the grinding disc on the grinding tool.

FIG. 3 is a further example of a robot-assisted grinder.

FIG. 4 shows an example of a magazine which allows for automatic mounting of grinding discs on a grinder.

FIG. 5 shows an example of a retaining ring of the magazine from FIG. 4.

FIGS. 6 and 7 illustrate, by way of example the progression of the automatic mounting of a grinding disc from the magazine on a grinder.

FIG. 8 illustrates an example of the automatic mounting of a grinding disc from the magazine on a grinder, with reference to a flow diagram.

FIG. 9 illustrates, by way of example, a partial aspect of the method from FIG. 8.

FIG. 10 illustrates a removal device for automatic removal of grinding discs from the carrier plate of a grinder.

FIG. 11-16 illustrate a plurality of (intermediate) steps of the removal process for automatic removal of grinding discs from the carrier plate of a grinder.

FIG. 17 illustrates an example of the automated removal process for automated removal of grinding discs, on the basis of a flow diagram.

FIG. 18 shows a modification/extension of the example from FIG. 10.

### DETAILED DESCRIPTION

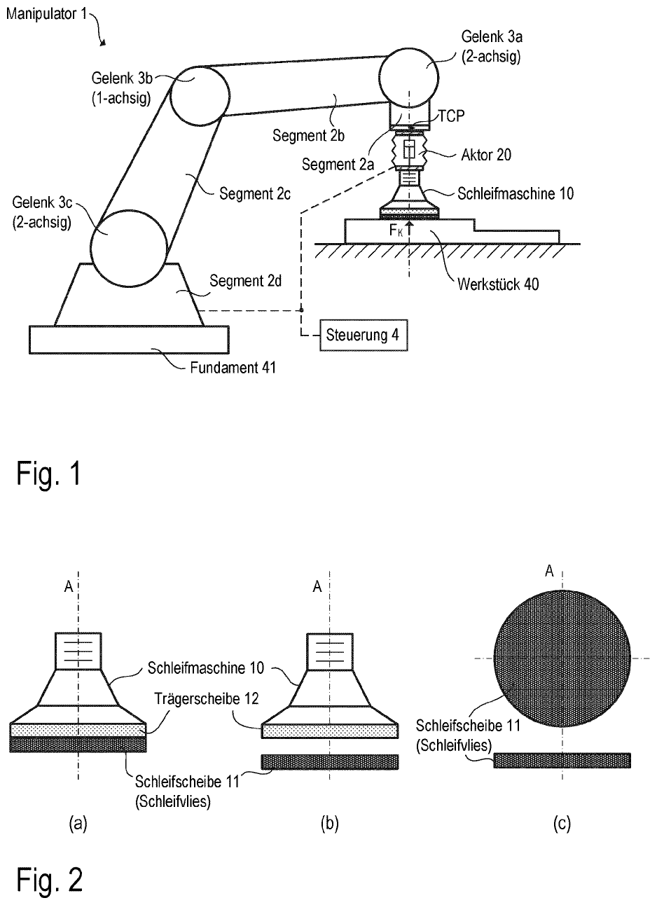

Before various embodiments of the present invention are explained in detail, firstly an example of a robot-assisted grinder is described. This comprises a manipulator 1, for example an industrial robot, and a grinder 10 having a rotating grinding tool (e.g. an orbital grinder), wherein this is coupled to the end-effector and thus to the TCP of the manipulator 1 via a linear actuator 20. In the case of an industrial robot having six degrees of freedom, the manipulator can be constructed of four segments 2a, 2b, 2c and 2d, which are in each case connected via joints 3a, 3b and 3c (see FIG. 1). In this case, the first segment 2d is usually rigidly connected to a base 41 (which, however, does not necessarily have to be the case). The joint 3c connects the segments 2c and 2d. The joint 3c can be biaxial and can allow a rotation of the segment 2c about a horizontal axis of rotation (elevation angle) and a vertical axis of rotation (azimuth angle). The joint 3b connects the segments 2b and 2c and allows for a pivot movement of the segment 2b relative to the position of the segment 2c. The joint 3a connects the segments 2a and 2b. The joint 3a can be biaxial and can therefore allow (similarly to the joint 3c) a pivot movement in two directions. The segment 2a forms the end-effector and consequently as a fixed relative position with respect to the TCP. Typically, the segment 2a also has a rotary joint (not shown) which allows for a rotational movement about a longitudinal axis of the segment 2a (shown in FIG. 1 as a dot-dashed line, corresponds to the axis of rotation of the grinding tool). Each axis of a joint is associated with an actuator, which can bring about a rotational movement about the respective joint axis. The actuators in the joints are actuated by a robot controller 4 according to a robot programme.

The manipulator 1 is typically position-controlled, i.e. the robot controller can specify the posture (location and orientation) of the TCP and can move this along a predefined trajectory. If the actuator 20 rests on an end stop, the posture of the TCP also defines the posture of the grinding tool. As already mentioned at the outset, the actuator 20 serves to set the contact force (process force) between the tool (grinder 10) and the workpiece 40 to a desired value, during the grinding process. A direct force regulation by the manipulator 1 is generally too imprecise for griding applications, since the high inertia of the segments 2a-c of the manipulator 1 means that a quick compensation of force peaks (e.g. when placing the grinding tool on the workpiece 40) is virtually impossible using conventional manipulators. For this reason, the robot controller is configured for controlling the posture of the TCP of the manipulator, while the force regulation can be brought about exclusively by the actuator 20.

As already mentioned, during the grinding process the contact force FK between the tool (grinder 10) and workpiece 40 can be set, with the aid of the (linear) actuator 20 and force regulation (which can be implemented for example in the controller 4), in such a way that the contact force between the grinding tool and the workpiece 40 corresponds to a specifiable target value. In this case, the contact force is a response to the actuator force, with which the linear actuator 20 presses on the workpiece surface (the weight force of the grinder is also added to this). In the case of a lack of contact between the workpiece 40 and the tool, the actuator 20 strikes an end stop owing to the lack of contact force on the workpiece 40. The position control of the manipulator 1 (which can also be implemented in the controller 4) can operate entirely independently of the force control of the actuator 20. The actuator 20 is not responsible for the positioning of the grinder 10, but rather merely for setting and maintaining the desired contact force during the grinding process, and for identifying contact between the tool and workpiece. The actuator can be a pneumatic actuator, e.g. a double-acting pneumatic cylinder. However, other pneumatic actuators can also be used, such as bellows cylinders and air muscles. As an alternative, electric direct drives (gearless electric drives) are also possible.

In the case of a pneumatic actuator, the force regulation can be achieved in a manner known per se, with the aid of a regulating valve, a regulator (implemented in the controller 4), and a compressed air reservoir. However, the specific implementation is not important for the further explanation, and is therefore also not described in more detail.

The grinder 10 comprises a grinding disc 11 which is mounted on a carrier disc 12. The surface of the carrier disc 12 or the rear surface of the grinding disc 11 or both surfaces are provided such that the grinding disc 11 readily adheres to the carrier disc 12 upon contact. For example, a hook-and-loop fastener is used, such that the grinding disc 11 remains adhered to the carrier disc. A detachable adhesive connection, a detachable latching connection, or similar, could also be used.

FIG. 2a shows the grinder 10 comprising a mounted grinding disc 11. During operation, the carrier disc 12 is driven by an electric motor of the grinder 10, and the grinding disc 11 rotates together with the carrier disc 12 (axis of rotation A). In the case of an orbital grinder, the carrier disc 12 preforms a more complex movement, specifically a rotation about two parallel axes of rotation having a defined axial offset. The grinding disc 11 consists for example of a grinding fleece, is flexible (pliable), and can be removed from the carrier disc. FIG. 2b shows the grinder 10 having a removed grinding disc 11. FIG. 2c also shows, in addition to the side view, a view of the grinding disc 11 from below (in the direction of the axis of rotation A).

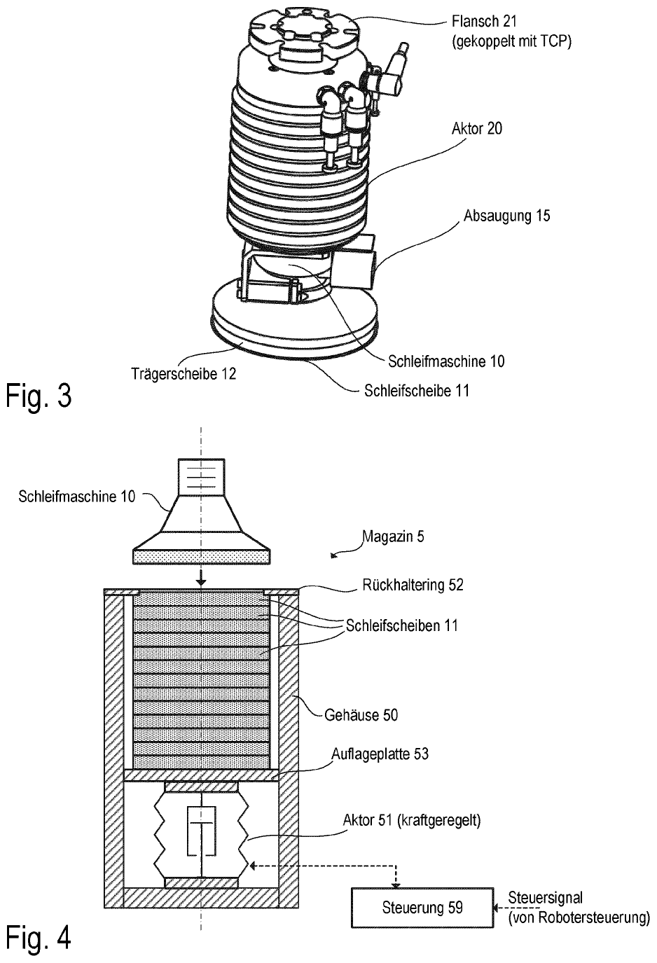

FIG. 3 shows a further example of a grinder 10 mounted on an actuator 20. The actuator 20 comprises a first flange 21, which can be rigidly connected to the manipulator 1 (e.g. end-effector 2a in FIG. 1). A second flange (hidden in FIG. 3) is located on the end of the actuator 20 opposite the flange 21, on which second flange the grinder 10 is mounted. FIG. 3 also shows e.g. the connection 15 for a hose, via which suctioning of grinding dust can take place. However, grinding dust suctioning is optional. At this point it is noted that grinding fleece discs are usually much thicker than is shown in FIG. 3.

Despite automation of the grinding process using robot-assisted grinders, the changing of the grinding disc still often takes place manually, in that an operator grips the grinding disc 11 at the edge, between their thumb and forefinger, and thereafter said disc is removed from the carrier disc. Existing automatic solutions for automatic changing of grinding discs are relatively complicated, wherein the complexity for example results from the fact that the grinding disc 11 has to be gripped by a mechanical device before removal. The embodiments described here can offer advantages in particular in the case of thick and flexible grinding discs (e.g. made of grinding fleece). In the following, firstly a magazine for grinding discs is described, which allows for automatic equipping of a grinder guided by a robot, with a (new) grinding disc. Furthermore, a corresponding method is described. Subsequently, a removal device is described which allows for automatic removal of grinding discs from the carrier plate of the grinder, and a corresponding method.

FIG. 4 shows an example of a magazine 5, which allows for automatic mounting of grinding discs 11 on a grinder 10. The magazine 5 comprises a frame or a housing 50. In the example shown, a support plate 53 is displaceably mounted in the housing. A stack of grinding discs 11 is located in the housing 50, on the contact plate 53. A linear actuator 51 is connected to the contact plate 53. Said linear actuator is configured for pressing the contact plate 53, with the grinder disc stack, upwards. In the example shown, the actuator 51 is also located in the housing 50, below the contact plate 53. The actuator 51 may be a pneumatic actuator, for example a pneumatic cylinder. However, other types of linear actuators can also be used, for example a bellows cylinder or also an electrical direct drive. The actuator 51 can also contain a combination of an active drive and a (passive) spring.

In the example shown, a retaining ring 52 is arranged on the upper side of the housing 50 in such a way that the actuator 51 presses the stack of grinding discs 11 against an underside of the retaining ring 52. The actuator force FA, with which the linear actuator 51 presses the uppermost grinding disc against the retaining ring 52 can be set. For this purpose, the actuator 51 is coupled to a controller 59 which can set the force exerted by the actuator on the contact plate 53. The manner and purpose of the force regulation by the controller 59 will be explained in more detail below.

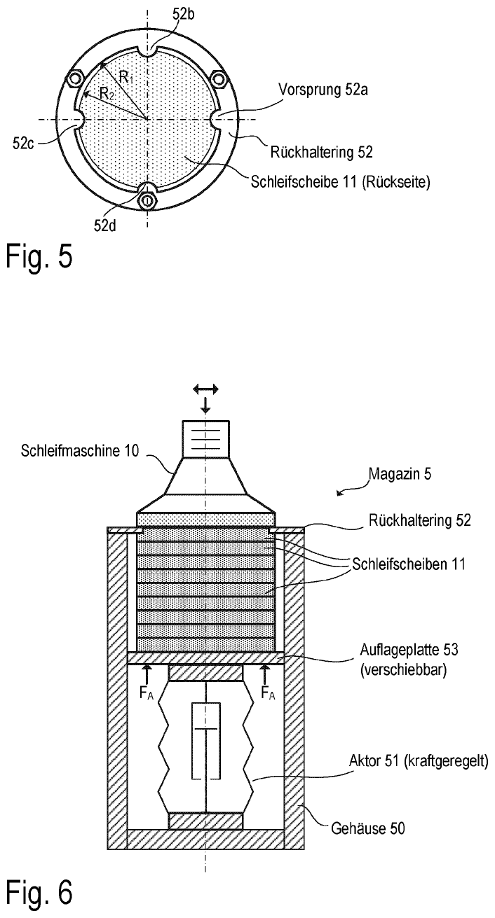

FIG. 5 shows an example of the retaining ring 52 of the magazine 5 from FIG. 4. The maximum inside diameter of the retaining ring is denoted by R₁, whereas the outside diameter of the grinding discs 11 is denoted by R₂. The inside diameter R₁ of the retaining ring 52 is larger than the outside diameter R₂ of the grinding disc stack (R₁>R₂). In order to prevent the actuator 51 from being able to displace the grinding discs out of the magazine, the retaining ring 52 comprises one or more projections 52a-d, which protrude beyond (overlap) the edge of the uppermost grinding disc of the stack. That is to say that the projections 52a-d are directed inwards (towards the centre point of the retaining ring 52).

The actuator 51 is force-regulated with the aid of the controller 59. That is to say that the force with which the rear side of the uppermost grinding disc is pressed against the projections 52 a-d of the retaining ring 52 can be set (e.g. 50 Newtons). In the case of a pneumatic actuator, the force regulation can be achieved in a manner known per se, with the aid of a regulating valve (not shown), a regulator (implemented in the controller 59), and a compressed air reservoir (not shown). The specific implementation of a force regulation is known per se and is not important for the further explanation, and will therefore not be discussed further at this point.

FIG. 4 shows the magazine 5, filled with grinding discs, in an initial state, in which the actuator 51 presses the grinding disc stack upwards, against the retaining ring 52, with a defined (regulated) force F_{A}=F_{A1}. During operation of the magazine (after filling with grinding discs), the uppermost grinding disc of the stack contacts the retaining ring 52, i.e. the grinding disc stack is not lowered between two successive mounting processes, and the magazine 5 remains ready for use, without the grinding disc stack having to be raised before each equipping process (mounting process).

At the start of an equipping process, the robot positions the grinder 10 above the magazine, such that the carrier plate 12 of the grinding disc is located substantially coaxially to the grinding disc stack. In other words, the carrier plate 12 of the grinder 10 is positioned centrally above the grinding disc stack and substantially in parallel with the retaining ring 52, and is subsequently pressed against the upper side of the retaining ring with low force. Since the grinding disc stack is pressed actively upwards (by the actuator 51), the rear side of the uppermost grinding disc 11 contacts the underside of the carrier plate 12. As a result, the rear side of the uppermost grinding disc 11 adheres to the underside of the carrier plate 12, because the two corresponding surfaces consist of a material which together form a hook-and-loop fastening. As mentioned, other connection techniques can also be used.

In particular when a hook-and-loop fastening, it may be advantageous for the robot to move the carrier plate 12 slightly back and forth, in parallel with the retaining ring 52, while the carrier plate 12 contacts the uppermost grinding disc. This slight movement leads to the loops and the hooks of the hook-and-loop fastener rigidly interconnecting (hooking together). This situation is shown in FIG. 6. The arrows symbolise the actuator force F_{A} of the actuator 51, the pressing of the grinder against the upper side of the retaining ring 52, and the mentioned movement in the transverse direction.

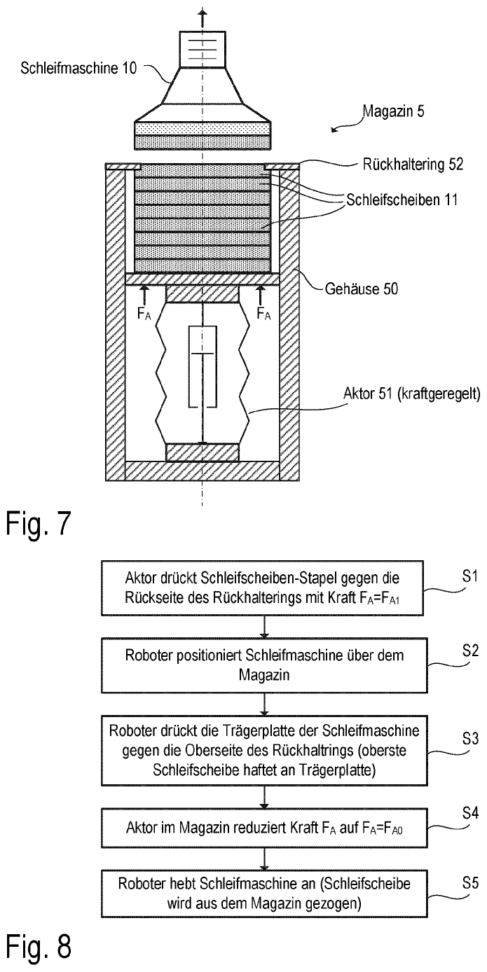

During the mounting process shown in FIG. 6, the actuator force F_{A1} must be relatively high in order that the uppermost grinding disc of the stack “oozes out” slightly, upwards, from the retaining ring 52, and the grinding disc 11 adheres well to the carrier disc. The pressing of the grinding disc stack clamps the uppermost grinding disc of the stack against the underside of the retaining ring 52 (against the projections 52a-d, see FIG. 5). This clamping can sometimes lead to the connection between the carrier plate 12 and the grinding disc 11 being released again when the grinder 10 is lifted off the magazine, and the mounting process failing. Therefore, in some systems, the grinding disc stack is lowered after the mounting process, in order to release the mentioned clamping. However, this lowering has the disadvantage that the grinding discs rub, along their periphery, on the inside of the frame/housing 50 or on other components in the inside of the housing, leading to wear. According to the embodiments described here, however, the actuator 51 operates in a force-regulated manner, and therefore it is possible to reduce the actuator force F_{A} from F_{A1} to F_{A0} (F_{A0}<F_{A1}) before lifting the grinder from the magazine, in order to significantly reduce the clamping effect and to allow for simple “pulling out” of the grinding disc from the magazine 5, without lowering the grinding disc stack (i.e. the grinding disc stack contacts the underside of the retaining ring the entire time). Thereafter, the actuator force F_{A} is increased again to the target value F_{A1}, and the magazine is immediately ready for the next mounting process. This situation is shown in FIG. 7. The support plate 53 is lowered only for filling the magazine 5 with new grinding discs (i.e. the force regulation is deactivated or the actuator force is reduced to zero).

The process described above is summarised in the following with reference to the flow diagram from FIG. 8. The grinding disc stack in the magazine 4 is pressed with a defined force F_{A1} from below against the retaining ring 52 (FIG. 8, step S1), and the magazine is ready for a new mounting process. The robot positions the grinder 10 (approximately coaxially to the retaining ring 52) above the magazine 5 (FIG. 8, step S2). Subsequently, the carrier plate of the grinder is pressed (e.g. with the actuator, see FIG. 3) against the retaining ring 52 (FIG. 8, step S3), and the uppermost grinding disc of the stack adheres to the carrier plate, for example by means of a hook-and-loop fastener. Before the grinder 10 is lifted from the magazine, the controller 59 (see FIG. 4) receives a signal (e.g. from the robot controller 4, see FIG. 1) which indicates that the actuator force F_{A} generated by the actuator 51 should be reduced, and the actuator 51 then reduces the force exerted on the grinding disc stack from F_{A1} to F_{A0} (FIG. 8, step S4). Subsequently, the grinder 10 is lifted from the magazine 5 and the mounting grinding disc is pulled out of the magazine (FIG. 8, step S5).

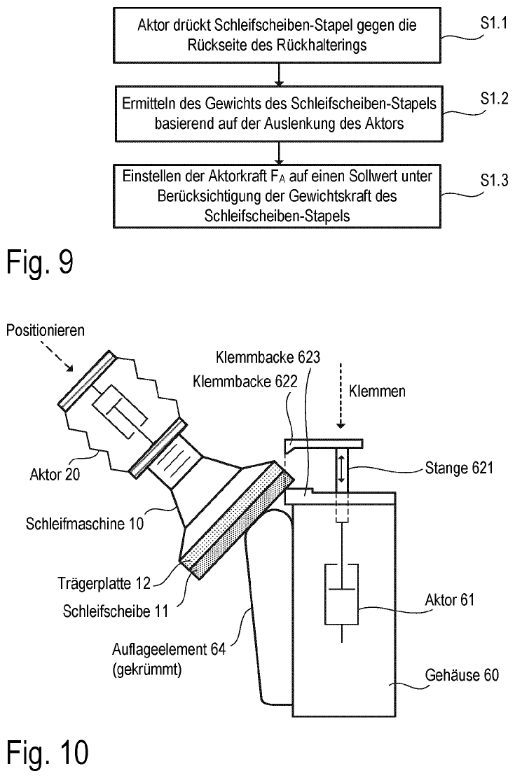

FIG. 9 illustrates a further aspect of the concept described herein for improving the precision of the force regulation, in that the weight force of the grinding disc stack is taken into account. Firstly, the actuator 51 presses the grinding disc stack against the rear side of the retaining ring 52 (FIG. 9, step S1.1). The actuator deflection (actuator position) depends on the number of grinding discs in the magazine. The fewer grinding discs there are in the stack, the further the actuator 51 has to deflect the support plate 53 upwards. The actuator deflection can be measured and, based on the measured actuator deflection, the controller 59 can calculate the weight force of the grinding disc stack (FIG. 9, step S1.2). For example, the number of grinding discs in the magazine can be calculated from the actuator deflection and a known thickness of the grinding discs. Since the weight of a single grinding disc is known, the total weight of the grinding disc stack can be determined from the determined number. Alternatively, the density (weight per height unit of the stack) of the grinding disc material (e.g. grinding fleece) can also be stored in the controller, such that the controller 59 can easily calculate the weight force of the stack currently located in the magazine, from the density and actuator deflection. Subsequently, when setting the actuator force F_{A}, the weight force of the stack can be taken into account (FIG. 9, step S1.2).

If for example the determined weight force of the grinding disc stack is 10 Newtons, then the actuator force FA is set to 40 Newtons (target force plus weight force), in order to effectively press the uppermost grinding disc against the retaining ring 52 with 30 Newtons. This prevents the actuator force (in particular the value F_{A0}) from becoming too great in the case of only a few grinding discs in the magazine 5. If for example the weight force is only 2 Newtons, the actuator force F_{A} must be reduced to 32 Newtons, in order to still press the uppermost grinding disc against the retaining ring 52 with 30 Newtons. Without taking the weight force into account, the force would be too high.

FIG. 10 illustrates a removal device 6 for automatic removal of grinding discs from the carrier plate of a grinder. In the example shown, the removal device comprises a housing 60 having a clamping mechanism 62. The housing 60 is not necessarily closed and can also be formed by a frame (open housing) or the like. The clamping mechanism 62 is formed by the clamping jaws 622 and 623 which are displaceable relative to one another in a clamping direction (sketched in FIG. 10 by the dashed arrow with the designation “clamping”). The clamping jaw 623 is a part of a plate that is arranged on the upper side of the housing 60, the clamping jaw 622 is mounted in or on the housing so as to be displaceable in the clamping direction (e.g. by means of a linear guide) and can be moved with the aid of a linear actuator 61. That is to say that the linear actuator 61 is configured for closing or releasing the clamping mechanism (along the clamping direction). A clamping edge of the clamping jaw 622 (on the left-hand side of the clamping jaw 622 in FIG. 10) is flush, in the clamping direction, with a corresponding edge of the clamping jaw 623. The actuator 61 can be any linear actuator, for example a pneumatic cylinder, an electrical linear actuator, etc.

A support element 64 is arranged on the side of the housing 60 on which the clamping jaws 622, 623 are located, which support element has a convexly curved outer contour on its outside (the side facing away from the housing). The clamping device 62 is opened before the removal process. The robot positions the grinder with the (worn) grinding disc 11 obliquely (with respect to the vertical clamping direction for example) in front of the support element 64 and subsequently presses the grinding disc against a part of the curved surface of the support element 64. The orientation of the grinder 10 is also shown in FIG. 10 by an arrow (denoted with the designation “positioning”). In the example shown, the axis of rotation of the grinder is oblique to the clamping direction, at approximately 45°. Of course, the camping direction does not necessarily extend along the vertical, but rather it is only a question of the grinder relative to the clamping direction. Proceeding form the situation shown in FIG. 10, the clamping device 62 can be closed with the aid of the actuator 61 in order to clamp the grinding disc 11 at one edge.

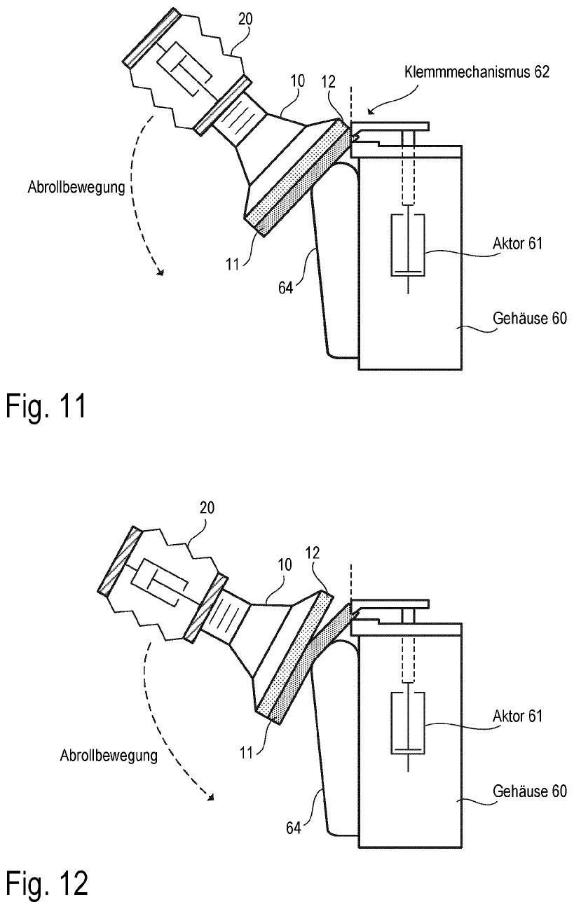

The actuator can comprise a sensor for detecting an end position (e.g. a limit switch). If, during closure of the clamping mechanism, the actuator 61 moves into its end position, then this is a sign that the grinding disc 11 has not been correctly clamped between the clamping jaws 622 and 623. In the situation shown in FIG. 11, the grinding disc 11 is correctly clamped between the clamping jaws 622 and 623 and the actuator therefore does not reach its end position. Apart from the closed clamping mechanism, FIG. 11 is identical to FIG. 10.

The oblique position of the grinder solves a plurality of problems which can arise in known concepts. According to a known approach (see the publication U.S. Pat. No. 8,517,799 B2), for releasing a grinding disc a separating plate is inserted between the carrier plate 12 and grinding disc 11, in parallel with the surface of the carrier plate 12. However, this approach functions only in the case of a known thickness of the grinding discs, in particular in the case of grinding paper. However, the thickness of the grinding disc is not always the same and can vary significantly (in particular in the case of relatively thick discs made of grinding fleece, which become thinner due to wear, such that the thickness of worn discs can vary significantly from case to case). According to another approach, the (worn) grinding disc is pressed against a flat support surface (which is in parallel with the carrier plate 12), and the grinding disc is clamped by a clamping jaw against the support surface. In this case, the clamping direction is in parallel with (not oblique to) the axis of rotation of the grinder. This approach only functions if the grinding disc is slightly larger than the carrier plate. This is often the case when emery cloths (known as “daisy discs”) are used.

The concept described here functions reliably even if the actual thickness of the grinding disc is not known and the grinding disc does not protrude beyond the carrier plate. The grinding disc can even have a slightly smaller diameter than the carrier plate 12 of the grinder. In FIG. 11, it can be easily seen that the lower edge (at the periphery of the grinding disc) comes to rest, via the oblique position, between the clamping jaws 622, 623, even if the grinding disc 11 is not larger (or even slightly smaller) than the carrier plate 12 on which the grinding disc 11 is mounted.

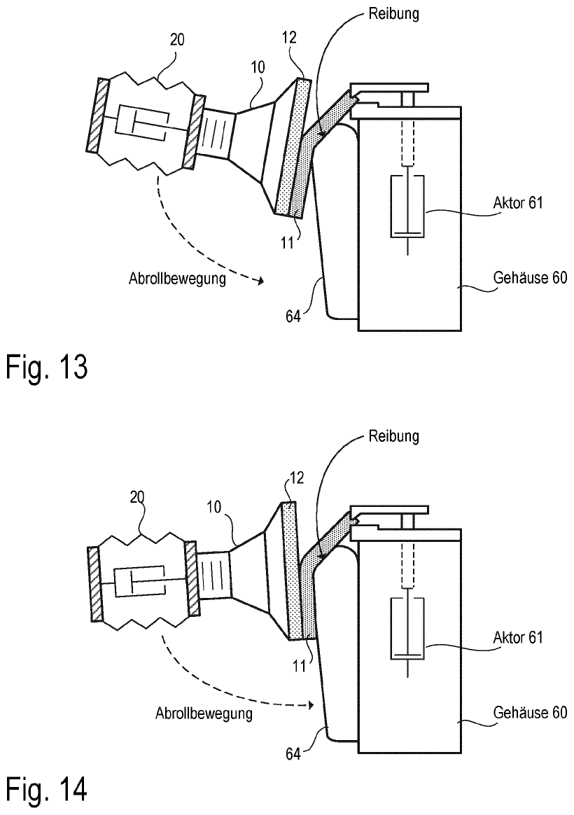

Proceeding from the situation shown in FIG. 11, the robot moves the grinder 10 such that the carrier plate 12 performs a rolling movement on the convexly curved surface of the support element 64, while the actuator 20 presses the carrier plate 12 against the support surface 64 (with lower force). During the rolling movement, the grinder 10 is rotated (rolled) away from the clamping mechanism. The mentioned rolling movement is shown by a plurality of intermediate steps in FIGS. 12, 13, 14 and 15. This rolling movement reduces the tensile force in the grinding disc in the region of the clamping, and prevents the grinding disc 11 from being torn out of the clamping mechanism 62 again before having been fully released from the carrier plate 12.

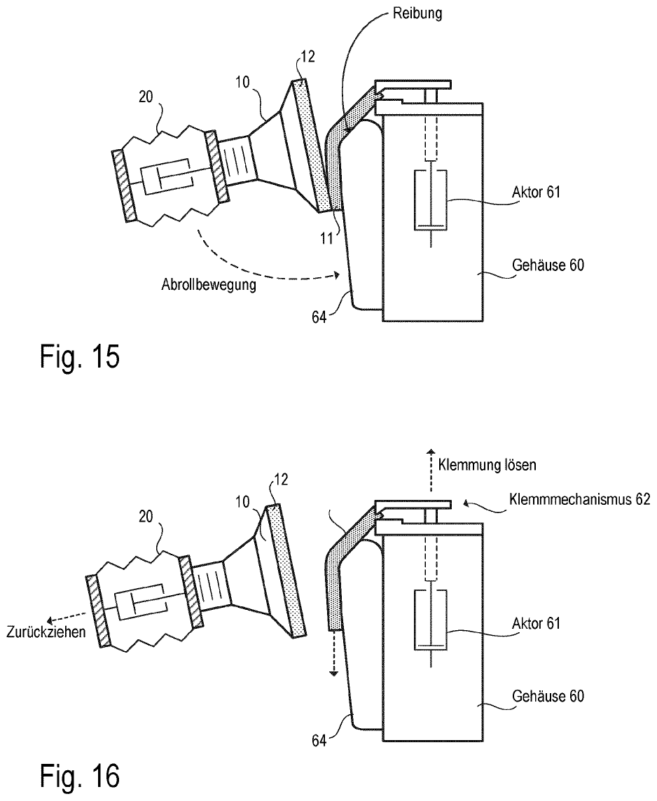

As can be seen in FIGS. 12, 13, 14 and 15, during the rolling process the flexible grinding disc 11 touches the curved surface of the support surface 64, which leads to a relatively high friction force (similar to in the case of winding a sail around a bollard), which prevents the load being fully introduced into the clamping mechanism during removal of the grinding disc. In this way, it is possible to reliably prevent the grinding disc 11 from being torn out of the clamping device 62 during the removal process. During the rolling movement of the grinder, the grinding disc 11 is released gradually from the carrier plate 12 (e.g. the hook-and-loop fastening is separated). The situation shown in FIG. 15 shows the end of the rolling movement, in which only a small part of the grinding disc 11 adheres to the carrier plate.

Proceeding from the situation shown in FIG. 15, the robot can retract the grinder 10, such that the carrier plate 12 lifts off from the surface of the support element 64, as a result of which the still adhering part of the grinding disc 11 is released from the carrier plate 12. Subsequently, the actuator 61 can be actuated such that the clamping mechanism 62 is opened again and the grinding disc 11 falls down (e.g. into a collecting container). The signal for closing and clamping the clamping device can be generated e.g. by the robot controller (cf. FIG. 1, robot controller 4).

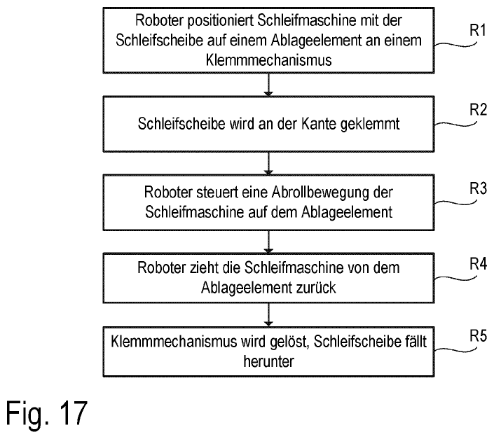

The removal process is summarised in the following with reference to the flow diagram shown in FIG. 17. According to FIG. 17, the robot positions the grinder 10 with the grinding disc 11 on a convexly curved deposition element 64 on a clamping mechanism 62 (FIG. 17, step R1), wherein the grinder 10 is positioned obliquely with respect to a clamping direction of the clamping mechanism 62, such that the clamping device 62 can clamp an edge on the periphery of the grinding disc 11. Subsequently, the grinding disc 62 is clamped at the edge (FIG. 17, step R2, clamping mechanism is activated). Subsequently, the robot controls a rolling movement of the grinder 10 on the deposition element 64, while the carrier plate 12 presses against the surface of the curved deposition element 64 (FIG. 17, step R3). Finally, the robot pulls the grinder 10 back from the deposition element 64 (FIG. 17, step R4), as a result of which the grinding disc 11 is finally released from the carrier plate 12. Subsequently, the clamping mechanism 62 can be released (FIG. 17, step R5) and the grinding disc 11 can fall down (e.g. out of the removal device into a collecting container).

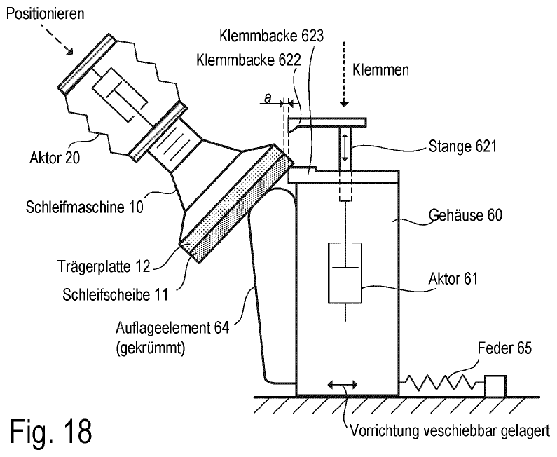

Of course, the removal device according to FIG. 10 and the magazine according to FIG. 4 can be combined to form a changing station. In view of the above description, it is clear that a person skilled in the art can supplement or modify the described embodiments in order to create further embodiments without changing the concept on which the embodiments are based. For example, the removal device according to FIG. 10 can be mounted so as to be displaceable in a (horizontal) direction and fixed by means of a spring, such that the removal device can be displaced against the spring force when the robot places the grinder with the grinding disc on the convexly curved deposition element. This situation is shown in FIG. 18, which shows a modification/extension of the example from FIG. 10. Very generally, the manipulator will position the grinder such that the edge of the carrier plate 12 comes to rest as close as possible to the clamping device (but only the grinding fleece protrudes into the clamping device), such that the clamping jaws 622 and 623 grip the grinding fleece as close as possible to the edge of the carrier plate 12 during closing of the clamping device (see FIG. 18, distance a as small as possible, theoretically zero).

The magazine from FIG. 4 can also be mounted so as to be displaceable in the vertical direction, against a spring force, such that the entire magazine yields when the robot places the grinder with the carrier plate on the magazine. These variants can be advantageous if the grinder is directly connected to the end-effector of the robot (without the actuator 20). In some applications, the actuator 20 (cf. FIG. 1) can be omitted, or the actuator 20 can be replaced by a passive spring. After removal of the grinding disc from the carrier plate, it is possible to verify, by means of visual inspection (e.g. by means of a camera), that the grinding disc has actually been completely removed. The visual inspection also makes it possible to verify whether the grinding disc adheres correctly to the carrier plate after the mounting process.

Finally, it should be noted that polishing is considered a special case of grinding, and therefore everything that has been described with reference to a grinder or a grinding process would apply similarly for a polishing machine and a polishing process.

1-15. (canceled)

16. A method for removing a grinding means from a from a robot-assisted grinder, the method comprising:
positioning, by a manipulator, the grinder on a curved deposition element of a removal device close to a clamping mechanism of the removal device;
clamping the grinding means by closing the clamping device;
performing a rolling movement of the grinder with the aid of the manipulator while the grinding means touches the curved deposition element, such that the grinding means is in part released from a carrier plate of the grinder;
retracting the grinder with the aid of the manipulator, such that the grinding means is detached completely from the carrier plate; and
releasing the clamping mechanism.

17. The method of claim 16, wherein the positioning of the grinder on the curved deposition element takes place such that an axis of rotation of the grinder is located in an oblique position with respect to a clamping direction of the clamping mechanism.

18. The method of claim 17, wherein the oblique position is approximately in a range of 30 to 60 degrees.

19. The method of claim 16, wherein the clamping mechanism closes in a vertical direction, and wherein the grinder is positioned obliquely to the vertical direction.

20. The method of claim 16, wherein the grinder is positioned such that an edge of the carrier plate is positioned as close as possible to the clamping mechanism and the grinding means protrudes into the clamping mechanism.

21. The method of claim 16, wherein the curved deposition element is convexly curved and the grinding means is clamped between the curved deposition element and the carrier plate during the rolling movement, while being held back on one side by the clamping mechanism.

22. The method of claim 16, wherein the removal device is mounted so as to be displaceable linearly, counter to the action of a spring force.

23. The method of claim 16, wherein positioning, by the manipulator, the grinder on the curved deposition element comprises pressing the grinding means against the curved deposition element by a linear actuator that couples the grinder to the manipulator.

24. The method of claim 23, wherein the manipulator is position-controlled and the linear actuator is force-controlled.

25. The method of claim 16, wherein the manipulator controls the rolling movement while the grinding means is pressed against a surface of the curved deposition element.

26. A method for automatically mounting a grinding means, provided in a magazine, on a carrier plate of a robot-assisted grinder, the method comprising:
pressing the grinding means against the rear side of a retaining ring with the aid of a linear actuator, wherein the linear actuator is force-regulated and the grinding means is pressed against the retaining ring with a defined contact force;
positioning the grinder above the magazine and pressing the carrier plate of the grinder against the upper side of the retaining ring with the aid of a manipulator, such that the grinding means adheres to the carrier plate;
reducing the contact force from a first value to a second, lower value; and
subsequently retracting the grinder from the magazine with the aid of the manipulator, such that the grinding means adhering to the carrier plate is pulled out of the magazine through the retaining ring.

27. The method of claim 26, further comprising:
increasing the contact force to the first value after the retracting of the grinder.

28. The method of claim 26, wherein the grinding means adheres to the carrier plate by an adhesive layer, magnetically or by a hook-and-loop fastener.

29. The method of claim 26, wherein the grinder performs an oscillating movement in parallel with the retaining ring, with the aid of the manipulator, while the carrier plate presses against the retaining ring.

30. The method of claim 26, wherein the grinding means is an uppermost one of a stack of grinding means which is arranged in the magazine on a support plate.

31. The method of claim 30, wherein the linear actuator presses the support plate upwards in a direction of the retaining ring and the stack of grinding means is not repeatedly raised and lowered during operation.

32. A removal device for removing a grinding means from a robot-assisted grinder, the removal device comprising:
a curved deposition element for the grinding means, which is mounted on a carrier plate of the grinder; and
a clamping mechanism configured to clamp the grinding means by closing the clamping mechanism in a clamping direction, while the grinding means is located in an oblique position with respect to the clamping direction, on the curved deposition element.

33. The removal device of claim 32, wherein the clamping mechanism is configured to close in a vertical direction, and wherein the curved deposition element is configured such that when the grinding means rests against the curved deposition element, the grinding means is positioned at an angle to the vertical direction.

34. The removal device of claim 33, wherein the oblique position is approximately in a range of 30 to 60 degrees.

35. The removal device of claim 32, wherein the removal device is mounted so as to be displaceable linearly, counter to the action of a spring force, and displaceable in a horizontal direction.

36. A device for automatic mounting of a grinding means, provided in a magazine, on a carrier plate of a robot-assisted grinder, the device comprising:
the magazine configured to receive a stack of grinding means and comprising a retaining ring;
a linear actuator configured to press the stack of grinding means against the retaining ring;
a controller for the linear actuator configured to adjust a contact force with which the stack of grinding means is pressed against the retaining ring, such that the contact force is of a defined first value,
wherein the controller is further configured to reduce the contact force from the first value to a lower second value while the stack of grinding means continues to be pressed against the retaining ring, to make it easier to pull out the first grinding means of the stack.
